(19) United States
(12) Patent Application Publication
(10) Pub. No.: US 2016/0069004 A1
(43) Pub. Date: Mar. 10, 2016

(54) FABRIC WITH LEVEL GRADIENT EFFECT

(71) Applicant: Yi-Yung CHEN, New Taipei City (TW)

(72) Inventor: Yi-Yung CHEN, New Taipei City (TW)

(21) Appl. No.: 14/482,353

(22) Filed: Sep. 10, 2014

(51) Int. Cl. D04B 1/12; B44F 1/10

(52) U.S. Cl. CPC D04B 1/126; B44F 1/10

(57) ABSTRACT

A fabric with level gradient effect contains: at least one yarn Y1, at least one yarn Y2, at least one yarn Y3. At least one of Y2 is knitted between Y1 and Y3. Y1, Y2, and Y3 is obtained by one of the conditions: (1) Each of Y1, Y2, and Y3 is dope dyed and has at least an identical pigment with three different content and account for X1, X2, and X3 wt % of fiber, and 1.03*X1≦X2≦0.97*X3, the fabric is further bath dyed to obtain level gradient color effect; (2) Each of Y1, Y2, and Y3 is cationic dyeable polyester yarn having the same sulfonic acid group with three different content of the sulfonic acid group and account for X1, X2, and X3 mol. % of fiber, and 1.03*X1≦X2≦0.97*X3, the fabric is further bath dyed to obtain level gradient color effect.

### FIELD OF THE INVENTION

The present invention relates to a fabric dyed with different dyeing manners or using different dyeability fibers and containing plural yarns knitted in suitable knitting sequence, and wherein the fabric is finally bath dyed to obtain level gradient color.

### BACKGROUND OF THE INVENTION

To acquire plentiful color fabric, the fabric could be dyed in different coloring time or using gradient colored fiber, thus having level gradient effect. However, the fabric is dyed in a limited manner.

FR Patent 2,682,130 disclosed a conventional dyeing method containing steps of: fixing a fabric on a support, placing the support into a dyeing bath, and setting dyeing time according to dyeing heights to produce the fabric with level gradient effect. Nevertheless, such a method has poor reproducibility and stability, and the fabric cannot be dyed in a closed dyeing bath to obtain stable color fastness.

A method of making fiber with gradient color contains steps of controlling output amount of the melt extruder in spinning process to change the colorant content as disclosed in WO 2010/012128, wherein as producing thermoplastic conjugate fiber, at least one melt extruder has dope dyeing and its output ratio is changed periodically, thus producing the fabric with gradient color. Unfortunately, the gradient fiber has also to be used continuously in a single fiber feeding condition in order to get gradient color effect, such as weft of woven fabric. In case of the warp of woven fabric, warp knitted fabric or circular knitted fabric can hardly be made of a continuously single yarn to cause level gradient effect.

The present invention has arisen to mitigate and/or obviate the afore-described disadvantages.

### SUMMARY OF THE INVENTION

One aspect of the present invention is to provide a fabric with level gradient effect which is capable of overcoming the shortcomings of the conventional fabric.

To obtain the above, a fabric with level gradient effect of the present invention contains: at least one yarn Y1, at least one yarn Y2, and at least one yarn Y3. During knitting, at least one of the at least one yarn Y2 is arranged to be located between the at least one yarn Y1 and the at least one yarn Y3. Each of the at least one yarn Y1, the at least one yarn Y2, and the at least one yarn Y3 is dope dyed with at least one identical pigment in three different contents, three contents of such identical pigments of the at least one yarn Y1, the at least one yarn Y2, and the at least one yarn Y3 account for X1, X2, and X3 wt % of fiber, and 1.03*X1≦X2≦0.97*X3. The fabric is further bath dyed to obtain level gradient color effect.

To obtain different contents of the pigment of the dope dyed yarn, the at least yarn Y1, the at least one yarn Y2 and the at least one yarn Y3 can be either spun by ways of single composite spinning with a single melt extruder or conjugate fiber spinning with at least two melt extruders. In case of single composite spinning with a single melt extruder to spin the at least yarn Y1, the at least one yarn Y2 and the at least one yarn Y3, the dosing amount of masterbatch which contains at least one pigment is changed by adjusting the letdown ratio of the dosing unit. Different dosing amount of the masterbatch will obtain dope dyed yarn with different content of pigment. The letdown ratio of the masterbatch is settled according to the desired target of the pigment content of the dope dyed yarn. When the dosing amount of the masterbatch is exceeding the suitable letdown range of the dosing unit, either too large or too small, the pigment formulations of the masterbatch should be reorganized to fit in the workable range of the dosing unit. In case of conjugate fiber spinning with at least two melt extrudes to spin the at least yarn Y1, the at least one yarn Y2 and the at least one yarn Y3, at least one composite should be dope dyed by the masterbatch with at least one pigment. Before the conjugating of the at least two composites, each composite should pass through a gel pump to control the input of each composite into the conjugating spinning plates. By adjusting the gel pump which controlling the input of the dope dyed composite will promptly change the output ratio of the dope dyed composite, hence dope dyeing yarns with different content of the pigment are produced. All types of conjugate style are all suitable on this application as all types of conjugating may change the pigment content by changing the output ratio of the dope dyed composite.

The colorant used for dope dyeing are selected from pigment and dye. However, when select the dye material, such as soluble dye or disperse dye, migration is inevitable during the bath dyeing process, even the dye content is not high. In contrast, when selecting pigment only, the migration is evitable as long as the pigment content is not exceeding the overloading concentration. Since the pigment in the fibers is not migrating during the bath dyeing process, these fibers maintain their pigment content individually. Meanwhile, the pigment in the fiber does not have significant influence on the dye absorption during bath dyeing. Eventually these fibers have the same dye content coming from bath dyeing and different pigment content coming from the dope dyeing process. Furthermore, knitting sequence has to be arranged based on pigment contents in order to form the fabric with beautiful level gradient.

As selecting the at least yarn Y1, the at least one yarn Y2 and the at least one yarn Y3 with three different contents of pigment, the three different contents of the pigment account for X1, X2, and X3 wt % of the fiber, and X1<X2<X3, wherein during the knitting process, one or plural yarns Y2 should be defined between one or plural yarns Y1 and one or plural yarns Y3, and after the fabric is bath dyed, the content of the pigment of the at least one yarn Y1 is still the lowest, the content of the pigment of the at least one yarn Y2 is higher than the at least one yarn Y1 and is lower than the at least one yarn Y3, and the content of the pigment of the at least one yarn Y3 is still the highest. Due to the at least one yarn Y2 is defined between the at least one yarn Y1 and the at least one yarn Y3, the level gradient effect of the fabric presents. It is to be noted that when the difference of the pigment content of the at least one yarn Y1, the at least one yarn Y2 and the at least one yarn Y3 is too small, the quality control of the dope dyeing becomes difficult, so the difference of the pigment content is preferred to be not less than 3%, i.e., X1, X2 and X3 comply with 1.03*X1≦X2≦0.97*X3. The fabric is further bath dyed to obtain level gradient color effect.

Besides, in order to increase appearance plentiful design of the fabric, the knitting sequence could be partially arranged alternatively. However, at least one yarn Y2 should be arranged between at least one yarn Y1 and at least one yarn Y3. For instance, 5 yarns of Y1, 5 yarns of Y2 and 5 yarns of Y3 are arranged the knitting sequence as: Y1, Y1 ,Y1, Y1 ,Y2, Y1 ,Y2, Y2, Y2, Y3, Y2, Y3, Y3, Y3, Y3. One of the yarn Y2 is arranged before one yarn of Y1 and one of the yarn Y3 is arranged before one yarn of Y2. However, 3 yarns of Y2 is still defined between the 5 yarns Y1 and the 5 yarns Y3 and the fabric would obtain level gradient effect.

In addition to the dope dyeing method controlling the pigment content, another fabric with level gradient effect of the present invention contains: at least one yarn Y1, at least one yarn Y2, and at least one yarn Y3. During knitting, at least one of the at least one yarn Y2 is arranged to be located between the at least one yarn Y1 and the at least one yarn Y3. Each of the at least one yarn Y1, the at least one yarn Y2, and the at least one yarn Y3 are all cationic dyeable polyester contains the same sulfonic acid group but in three different contents. These three different content of the sulfonic acid groups account for X1, X2, and X3 mol. % of fiber, and 1.03*X1≦X2≦0.97*X3. The fabric is further bath dyed to obtain level gradient color effect.

In order to achieve different content of sulfonic acid group of polyester yarn, the at least one yarn Y1, the at least one yarn Y2, and the at least one yarn Y3 can be spun by single composite with a single melt extruder or spun by conjugate fiber with at least two melt extruders, and the sulfonic acid groups account for X1, X2, and X3 mol. % of the fiber, and 1.03*X1≦X2≦0.97*X3. The fabric is further bath dyed to obtain level gradient color effect. In case of spinning with a single melt extruder, mixing different ratio of normal polyester chips and cationic dyeable polyester chips before extrusion will obtain different dyeability polyester with different content of the cationic dyeable sulfonic acid group. In case of spinning conjugate fiber with at least two melt extruder, at least one of the composite should select the cationic dyeable polyester with sulfonic acid group and the rest composites could select from resins free from sulfonic acid group such as polyester resin or polyamide resin. During the spinning of the conjugate fiber, change the output ratio of the sulfonic acid group contained composite will obtain conjugate fiber with different content of sulfonic acid group. Although all different types of conjugating style could all reach the target to obtain different content of sulfonic acid group, sheath-core type is not suitable especially when the sulfonic group contained core composite is wholly covered by the sheath composite without containing sulfonic group, the difficulty is that the dye is not easy to pass through the sheath layer during bath dyeing process. So it is preferred to select the conjugate type without wholly covering any of the composite, such as side-by-side conjugate style or segmented pie division conjugate style.

Each of the at least one yarn Y1, the at least one yarn Y2, and the at least one yarn Y3 is selected from different dyeability yarn with different content of sulfonic acid group. When knitting the yarns Y1, Y2 and Y3, and each of the yarns Y1, Y2 and Y3 has three different sulfonic acid group content account for X1, X2, and X3 mol. % of the fiber, and X1<X2<X3. In the knitting process, one or plural yarns Y2 should be defined between one or plural yarns Y1 and one or plural yarns Y3, and after the fabric is bath dyed by at least cation dyes, the yarn which has more content of sulfonic acid group will absorb more concentration of cation dye. Due to at least one or the plural yarns Y2 are defined between the one or the plural yarns Y1 and the one or the plural yarns Y3, the level gradient effect of the fabric generates. It is to be noted that when the difference of the content of sulfonic acid group of the one or the plural yarns Y1, the one or the plural yarns Y2 and the one or the plural yarns Y3 is too small, quality control of the spinning with different content of sulfonic acid group becomes difficult, so the difference of the content of sulfonic acid group is preferred not to less than 3%, i.e., X1, X2 and X3 comply with 1.03*X1≦X2≦0.97*X3. The fabric is further bath dyed to obtain level gradient color effect.

Besides, as mentioned above, in order to increase appearance plentiful design of the fabric, the knitting sequence could be partially arranged alternatively. However, at least one yarn Y2 should be arranged between at least one yarn Y1 and at least one yarn Y3 in order to obtain level gradient effect.

### DETAILED DESCRIPTION OF THE PREFERRED EMBODIMENTS

A fabric with level gradient effect according to a first embodiment of the present invention is solution dyed polyester fiber with different contents of carbon black (CI Index No. is Pigment Black 7) and comprises at least one yarn Y1, at least one yarn Y2, at least one yarn Y3, at least one yarn Y4, and at least one yarn Y5 which are 75D/72F polyester draw-textured yarn, wherein the at least one yarn Y1, the at least one yarn Y2, the at least one yarn Y3, the at least one yarn Y4, and the at least one yarn Y5 are dope dyed to make the yarns containing different content of carbon black and accounted for 0.06 wt %, 0.12 wt %, 0.18 wt %, 0.24 wt %, and 0.30 wt % of fibers respectively. As knitting single jersey by using a weft knitting machine, a knitting sequence of the single jersey is : yarn Y1, yarn Y1, yarn Y1, yarn Y2, yarn Y2, yarn Y2, yarn Y3, yarn Y3, yarn Y3, yarn Y4, yarn Y4, yarn Y4, yarn Y5, yarn Y5, and yarn Y5, and the fabric is further bath dyed by a scarlet disperse dye at deep concentration. Finally the yarn Y1 are still scarlet appearance since it has the lowest carbon black concentration. While the yarn Y2, the yarn Y3, the yarn Y4, and the yarn Y5 are more and more blackish and become dark red because they have more and more carbon black concentration.

A fabric with level gradient effect according to a second embodiment of the present invention are made of different dyeability of polyester yarn containing different content of sulfonic acid group, wherein the difference of the content of sulfonic acid group is coming from different mixing ratio of cationic dyeable polyester resin chips and polyester resin chips. The cationic dyeable polyester resin contains 2 mol. % of 5-sodium sulfoisophthalate groups in the polymer chain and the polyester resin does not have sulfonic acid groups included. To make the yarn Y1, 90 wt % of polyester resin chips and 10 wt % of the cationic dyeable polyester resin chips are prepared and mixed, dried, and are melted and extruded by using a single melt extruder, thereafter are spun and draw-textured to form 75D/48F DTY yarn. The at least one yarn Y2, the at least one yarn Y3, the at least one yarn Y4 and the at least one yarn Y5 are all made by the same spinning process but have different mixing ratio of cationic dyeable polyester resin chips and polyester resin chips. To make the yarn Y2, a weight percentage ratio of 80 wt % of the polyester resin chips and 20 wt % of the cationic dyeable polyester resin chips are prepared. To make the yarn Y3, a weight percentage ratio of 70 wt % of the polyester resin chips and 30 wt % of the cationic dyeable polyester resin chips are prepared. To make the yarn Y4, a weight percentage ratio of 60 wt % of the polyester resin chips and 40 wt % of the cationic dyeable polyester resin chips are prepared. To make the yarn Y5, a weight percentage ratio of 50 wt % of the polyester resin chips and 50 wt % of the cationic dyeable polyester resin chips are prepared. Therefore the at least one yarn Y1, the at least one yarn Y2, the at least one yarn Y3, the at least one yarn Y4, and the at least one yarn Y5 have different content of 5-sodium sulfoisophthalate groups and accounted for 0.2 mol. %, 0.4 mol. %, 0.6 mol. %, 0.8 mol. %, and 1.0 mol. % of fibers respectively. As knitted single jersey by using a weft knitting machine, a knitting sequence of the single jersey is: Y1, Y1, Y1, Y2, Y2, Y2, Y3, Y3, Y3, Y4, Y4, Y4, Y5, Y5, Y5. Thereafter, the fabric is bath dyed by using two different dyes: a blue disperse dye at deep concentration and a black cation dye at medium concentration. The blue disperse dye is absorbed equally by each yarn but the black cation dye is absorbed the most by Y5 and the least by Y1 since Y1 has the least content of the sulfonic acid group. Finally the yarns Y1 are still blue shade appearance as Y1 has the lowest sulfonic acid group content and absorb the minimal quantity of black cation dye. While the yarn Y2, the yarn Y3, the yarn Y4, and the yarn Y5 have the color shade more and more blackish, since they are dyed by more and more black cation dye due to more and more sulfonic acid groups contained, and the yarn Y5 become a dark blue color which close to bluish black color shade.

A fabric with level gradient effect according to a third embodiment of the present invention comprises a first composite A and a second composite B, wherein the first composite A is polyester resin, and the second composite B is cationic dyeable polyester resin with 2 mol. % of 5-sodium sulfoisophthalate, and the first composite A and the second composite B are conjugating in a segmented pie division conjugate manner. For example, when spinning at least one yarn Y1, the output ratio of the first composite A is 70% and the cross section of composite A is then 70% of the fiber, and output ratio of the second composite B is 30% and the cross section of composite B is then 30% of the fiber. When spinning the at least one yarn Y2, output ratio of the first composite A is 60%, and output ratio of the second composite B is 40%. When spinning the at least one yarn Y3, output ratio of the first composite A is 50%, and output ratio of the second composite B is 50%. When spinning the at least one yarn Y4, output ratio of the first composite A is 40%, and output ratio of the second composite B is 60%. And, when spinning the at least one yarn Y5, output ratio of the first composite A is 30%, and output ratio of the second composite B is 70%. The fiber is 120D/48F partial oriented yarn (POY) and is draw-textured 1.6 times to form 75D/48F DTY yarn, wherein the at least one yarn Y1, the at least one yarn Y2, the at least one yarn Y3, the at least one yarn Y4, and the at least one yarn Y5 contain 5-sodium sulfoisophthalate accounted for 0.6 mol. %, 0.8 mol. %, 1.0 mol. %, 1.2 mol. %, and 1.4 mol. % of fibers. Due to the first composite A and the second composite B are congugated in a segmented pie division manner, both of the composite expose outside, wherein composite B of the at least one yarn Y1 accounts for a least cross section of the fiber, meanwhile the cationic dyeable polyester resin of the at least one yarn Y1 exposes outside at a least area. While cationic dyeable polyester resin of the at least one yarns Y2, Y3, Y4, Y5 expose outside more and more area as composites B of the at least one yarns Y2, Y3, Y4, Y5 account for more and more cross sections of the fiber.

As knitted single jersey by using a weft knitting machine, a knitting sequence of the single jersey is yarn Y1, yarn Y1, yarn Y1, yarn Y2, yarn Y2, yarn Y2, yarn Y3, yarn Y3, yarn Y3, yarn Y4, yarn Y4, yarn Y4, yarn Y5, yarn Y5, and yarn Y5. Thereafter, the fabric is dyed by a yellow disperse dye at deep concentration and a red cation dye at medium concentration. Finally the yarns Y1 are dyed by the red cation dye at a minimum ratio, as cationic dyeable polyester of the yarns Y1 expose outside at a least area, so that the yarns Y1 are in a golden yellow color appearance. While the yarns Y2, the yarns Y3, the yarns Y4, and the yarns Y5 are more and more reddish to be orange color appearance, because they are dyed by more and more red cation dye on more and more sulfonic acid groups, as their cationic dyeable polyester expose outside at more and more area.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A fabric with level gradient effect comprising:
at least one yarn Y1, at least one yarn Y2, and at least one yarn Y3; at least one of the at least one yarn Y2 being arranged to be located between the at least one yarn Y1 and the at least one yarn Y3, each of the at least one yarn Y1, the at least one yarn Y2, and the at least one yarn Y3 is dope dyed and has at least an identical pigment with three different contents, the contents of the identical pigment of the at least one yarn Y1, the at least one yarn Y2, and the at least one yarn Y3 accounting for X1, X2, and X3 wt % of fiber, and 1.03*X1≦X2≦0.97*X3, the fabric is further bath dyed to obtain level gradient color effect.

2. The fabric with level gradient effect as claimed in claim 1, wherein the at least one yarn Y1, the at least one yarn Y2, and the at least one yarn Y3 are spun by a single melt extruder; when spinning the at least one yarn Y1, the at least one yarn Y2 and the at least one yarn Y3, they are dope dyed by at least one identical pigment with three different content, the contents of the identical pigment account for X1, X2, and X3 wt % of the fiber, and 1.03*X1≦X2≦0.97*X3, the fabric is further bath dyed to obtain level gradient color effect.

3. The fabric with level gradient effect as claimed in claim 1, wherein the at least one yarn Y1, the at least one yarn Y2, and the at least one yarn Y3 are conjugate fiber include at least two composites made of at least two melt extruders, wherein at least one composite is dope dyed by at least one pigment, the output ratio of the dope dyed composite is changed such that the at least one yarn Y1, the at least one yarn Y2, and the at least one yarn Y3 have three different pigment content and the three contents of the pigment account for X1, X2, and X3 wt % of the fiber, and 1.03*X1≦X2≦0.97*X3, the fabric is further bath dyed to obtain level gradient color effect.

4. A fabric with level gradient effect comprising:
at least one yarn Y1, at least one yarn Y2, and at least one yarn Y3; at least one of the at least one yarn Y2 being arranged to be located between the at least one yarn Y1 and the at least one yarn Y3, each of the at least one yarn Y1, the at least one yarn Y2, and the at least one yarn Y3 is cationic dyeable polyester yarn having the same sulfonic acid group with three different content of the sulfonic acid group, and the contents of sulfonic acid groups account for X1, X2, and X3 mol. % of fiber, and 1.03*X1≦X2≦0.97*X3, the fabric is further bath dyed to obtain level gradient color effect.

5. The fabric with level gradient effect as claimed in claim 4, wherein the at least one yarn Y1, the at least one yarn Y2, and the at least one yarn Y3 are spun by a single melt extruder, and the contents of sulfonic acid groups account for X1, X2, and X3 mol. % of the fiber, and 1.03*X1≦X2≦0.97*X3, the fabric is further bath dyed to obtain level gradient color effect.

6. The fabric with level gradient effect as claimed in claim 4, wherein each of the at least one yarn Y1, the at least one yarn Y2, and the at least one yarn Y3 is conjugate fiber with at least two composites and is spun by at least two melt extruders, and the at least one yarn Y1, the at least one yarn Y2, and the at least one yarn Y3 have three different sulfonic acid groups content, and the contents of the sulfonic acid groups account for X1, X2, and X3 mol. % of the fiber, and 1.03*X1≦X2≦0.97*X3, the fabric is further bath dyed to obtain level gradient color effect.
